(19) United States
(12) Patent Application Publication
(10) Pub. No.: US 2011/0070492 A1
(43) Pub. Date: Mar. 24, 2011

(54) ELECTRODE FOR A LITHIUM SECONDARY BATTERY AND LITHIUM SECONDARY BATTERY EQUIPPED WITH SAME

(76) Inventors: Taisuke Yamamoto, Nara (JP); Hiromasa Yagi, Osaka (JP); Masaya Ugaji, Osaka (JP)

(21) Appl. No.: 12/993,712

(22) PCT Filed: May 20, 2009
(86) PCT No.: PCT/JP2009/002222

§ 371 Date: Nov. 19, 2010

(30) Foreign Application Priority Data
May 20, 2008 (JP) 2008-131504

(51) Int. Cl. H01M 4/26; H01M 4/58

(52) U.S. Cl. 429/218.1; 29/623.5; 29/623.1

(57) ABSTRACT

A method for producing an electrode for a lithium secondary battery according to the present invention includes (A) a step of causing a vaporized vapor deposition material to be incident on a surface of a current collector 11, having a plurality of bumps 12 at the surface thereof, in a direction 52 inclined with respect to the normal direction D to the surface of the current collector, thus to form an active material body 14 on each of the plurality of bumps 12 of the current collector 11; and (B) a step of stretching the current collector 11 having the active material bodies 14 formed thereon in at least one axial direction parallel to the surface of the current collector 11.

### TECHNICAL FIELD

The present invention relates to an electrode for a lithium secondary battery and a lithium secondary battery including the same.

### BACKGROUND ART

Recently, along with the development of portable devices such as personal computers, mobile phones and the like, there is an increasing demand for cells as power supplies of these devices. Cells for such uses are required to have a high energy density. In order to fulfill such a requirement, lithium secondary batteries are paid attention to. For both of a positive electrode and a negative electrode of a lithium secondary battery, active materials having a larger capacity than conventional active materials have been developed. Among these materials, single elements of silicon (Si) and tin (Sn), an oxide and an alloy thereof are considered to be promising as an active material for providing a very large capacity.

However, where an electrode for a lithium secondary battery is formed using such an active material, there is a problem that the electrode is deformed as charge/discharge is repeated. Any of the above-described active materials causes a significant volume change when reacting with lithium ions, and therefore significantly expands or contracts by the reaction occurring when lithium ions are inserted into, or released from, the active material during charge/discharge. Therefore, when the charge/discharge is repeated, the electrode receives a significant stress and so is distorted, which may undesirably cause wrinkles, breaks or the like. When the electrode is distorted and thus deformed, a gap is made between the electrode and the separator, which may undesirably make the charge/discharge reaction non-uniform and thus locally reduce the cell characteristics. For these reasons, it has been difficult to obtain a lithium secondary battery having a sufficiently high charge/discharge cycle characteristic using any of the above-mentioned active materials.

In order to solve these problems, it has been proposed to form a space in the active material layer for allowing the active material to expand.

For example, Patent Document No. 1 filed by the present applicant proposes an electrode in which an active material layer including a plurality of column-like active material bodies is formed on a surface of a current collector. The plurality of active material bodies are arranged with an interval held therebetween on the surface of the current collector. Such an electrode is produced by depositing a vaporized vapor deposition material (for example, silicon) on a current collector, having a plurality of bumps at a surface thereof, in a direction inclined with respect to the normal direction to the surface of the current collector (oblique vapor deposition). When being deposited by oblique vapor deposition, silicon is easily incident and deposited on a top part of each bump of the surface of the current collector, and is difficult to be deposited on an area of the surface which is in the shadow of the bump (and of the material deposited on the bump). Therefore, a column-like active material body containing silicon can be formed on each bump, and also a space for allowing the volume of the active material body to expand can be obtained with certainty between adjacent active material bodies. Owing to such a structure, the stress applied on the current collector by contact between the active material bodies expanded at the time of charge can be reduced, and thus the deformation of the electrode due to the contraction and expansion of the active material bodies can be suppressed.

Patent Document No. 2 proposes applying a tensile load on the current collector after forming an active material layer on the current collector, thus to form breaking lines in the active material layer. Patent Document No. 2 describes that the breaking lines formed in the active material layer act as a space for alleviating the stress generated by the expansion of the active material, and so the charge/discharge cycle characteristic can be improved.

### CITATION LIST

### Patent Literature

Patent Document No. 1: International Publication WO2009/019869 pamphlet

Patent Document No. 2: Japanese Laid-Open Patent Publication No. 2006-260928

### SUMMARY OF INVENTION

### Technical Problem

With the conventional method for producing an electrode, there are cases where a space for sufficiently alleviating the stress generated by the expansion of the active material is not formed in the active material layer.

As described in Patent Document No. 1, with the method of producing an electrode using oblique vapor deposition, a plurality of active material bodies are formed with an interval held therebetween using a shadowing effect. Therefore, it is difficult to make the interval between the active material bodies larger than an area of the surface of the current collector which is in the shadow of the bump or the like. As a result, as described below in more detail, it is occasionally difficult to increase the ratio of the space with respect to the active material layer, although the ratio depends on the height of the bumps of the current collector or the vapor deposition angle.

With the method described in Patent Document No. 2, there is a possibility that a sufficiently large space for alleviating the stress generated by charge/discharge is not formed merely by the breaking lines made in the active material layer by the tensile load. In addition, the electrode is further elongated by charge/discharge and as a result, the electrode may be undesirably wrinkled. Therefore, there is an undesirable possibility that the deformation of the electrode or the reduction of the cell reliability caused by the stress generated by charge/discharge of the cell is not effectively suppressed.

### Solution to Problem

A method for producing an electrode for a lithium secondary battery according to the present invention includes (A) a step of causing a vaporized vapor deposition material to be incident on a surface of a current collector, having a plurality of bumps at the surface thereof, in a direction inclined with respect to the normal direction to the surface of the current collector, thus to form an active material body on each of the plurality of bumps of the current collector; and (B) a step of stretching the current collector having the active material bodies formed thereon in at least one axial direction parallel to the surface of the current collector.

According to the present invention, in the step (A), the active material body is formed on each bump of the current collector, and so a space can be formed between adjacent active material bodies. Then, by stretching the current collector having the active material bodies formed thereon in step (B), the space between the active material bodies can be further enlarged. Therefore, a sufficiently large space for alleviating the expansion of the active material caused by charge/discharge can be formed.

Therefore, the deformation of the electrode due to the stress generated by the expansion of the active material can be suppressed, and so a lithium secondary battery having a splendid charge/discharge cycle characteristic and a high reliability can be provided.

### ADVANTAGEOUS EFFECTS OF INVENTION

According to the present invention, in an electrode for a lithium secondary battery including a current collector and a plurality of active material bodies formed on a surface of the current collector, a larger space can be formed between the active material bodies. As a result, the ratio of the space with respect to the active material layer including the plurality of active material bodies can be increased than in the conventional electrodes. Therefore, the stress applied on the current collector by contact between adjacent active material bodies when the active material bodies are expanded can be significantly suppressed. Thus, the deformation of the current collector due to the contraction and expansion of the active material bodies can be suppressed, and so the charge/discharge cycle characteristic and the reliability can be improved.

### BRIEF DESCRIPTION OF DRAWINGS

FIG. 1 is a schematic cross-sectional view showing an example of a conventional method for producing an electrode using oblique vapor deposition.

FIGS. 2(a) and (b) are schematic cross-sectional views for illustrating a vapor deposition step and a stretching step in an embodiment according to the present invention, respectively.

FIGS. 3(a) through (d) are schematic cross-sectional views for illustrating stages of the vapor deposition step in the method for producing an electrode in an embodiment according to the present invention.

FIGS. 4(a) and (b) are respectively a plan view and a cross-sectional view showing an example of a current collector usable in an embodiment according to the present invention.

FIG. 5 is a cross-sectional view for illustrating a vapor deposition device usable in the vapor deposition step in an embodiment according to the present invention.

FIGS. 6(a) through (c) schematically show a current collector after an active material layer is formed by the method for producing an electrode in an embodiment according to the present invention, and FIGS. 6(a) and (b) are cross-sectional views respectively taken along line I-I′ and line II-II′ in FIG. 6(c), and FIG. 6(c) is a plan view.

FIGS. 7(a) through (c) schematically show an electrode 200 obtained by the method for producing an electrode in an embodiment according to the present invention, and FIGS. 7(a) and (b) are cross-sectional views respectively taken along line I-I′ and line II-II′ in FIG. 7(c), and FIG. 7(c) is a plan view.

FIG. 8 is a schematic view showing a cylindrical cell using an electrode according to the present invention.

FIGS. 9(a) through (c) are schematic cross-sectional views for illustrating steps of a method for producing a current collector in an example and a comparative example.

FIG. 10 is a plan view showing the shape of a surface of the current collector in the example and the comparative example.

FIG. 11 shows a top surface of the active material layer in the comparative example.

FIG. 12(a) shows a top surface of an active material layer in Example 1, and FIG. 12(b) is an enlarged view of 12(a).

FIG. 13 illustrates a stretching step in Example 2.

FIG. 14 illustrates another stretching step performed by rolling.

### DESCRIPTION OF EMBODIMENTS

Hereinafter, an embodiment of a method for producing an electrode for a lithium secondary battery according to the present invention will be described. The method in the embodiment is applicable to produce both a negative electrode and a positive electrode of a lithium secondary battery, but is preferably usable to produce a negative electrode.

A method for producing an electrode according to the present invention includes a vapor deposition step of forming active material bodies on a surface of a current collector by oblique vapor deposition; and a stretching step of stretching the current collector having the active material bodies formed thereon in at least one axial direction which is parallel to the surface of the current collector. Owing to this, the space between the active material bodies can be enlarged as compared with in the conventional electrodes produced using oblique vapor deposition. The reason for this will be described below.

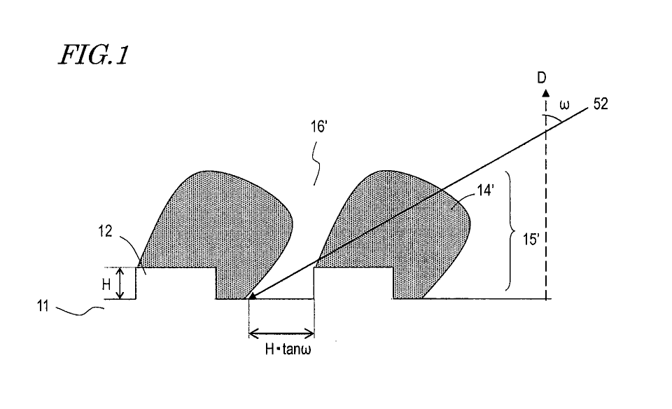

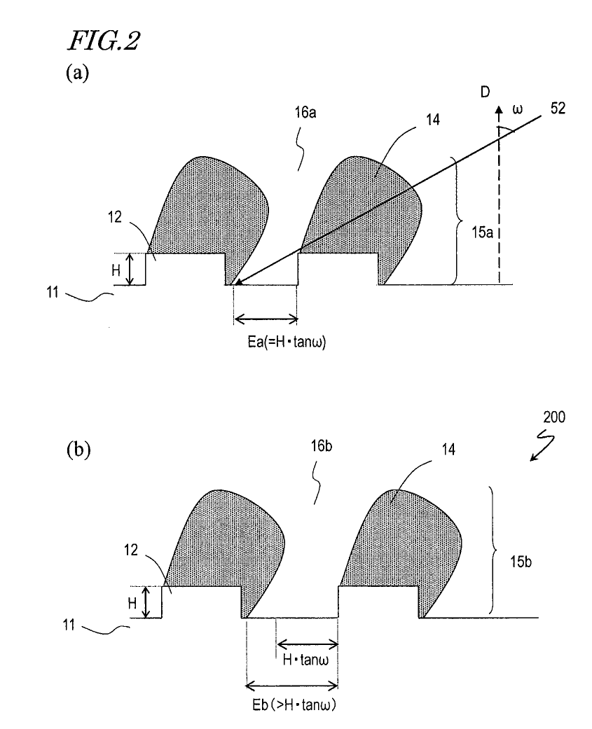

FIG. 1 is a schematic cross-sectional view showing an example of a conventional method for producing an electrode using oblique vapor deposition. FIGS. 2(a) and (b) are schematic cross-sectional views respectively for illustrating an overview of the vapor deposition step and an overview of the stretching step in this embodiment. For easier understanding, in the stretching step shown in FIG. 2(b), the current collector is stretched in a direction parallel to the vapor deposition direction on a plane parallel to the surface of the current collector, and the cross-section will be compared with the cross-section including the vapor deposition direction of the conventional electrode shown in FIG. 1.

First, a reason why it is difficult to make the interval between the active material bodies larger than a prescribed interval in the conventional electrode produced by oblique vapor deposition will be described in detail.

In the example shown in FIG. 1, a vapor deposition material is incident on a current collector 11 having a plurality of bumps 12 at a surface thereof in a direction 52 inclined by angle ω with respect to the normal D to the surface of the current collector 11. As a result, an active material body 14′ is formed on each bump 12. Between adjacent active material bodies 14′, a space 16′ is formed. The space 16′ is formed in an area which is in the shadow of the bump 12 having height H and on which the vapor deposition material is not incident. Therefore, where the bypassing of, or the collision between, the vapor deposition particles are ignored, a width of the space 16′ on the surface of the current collector 11 is determined by the height H of the bump 12 and the vapor deposition angle ω, and is H·tan ω.

With this method, even if the interval between the bumps 12 of the current collector 11 is made larger than H·tan ω, the width of the space 16′ on the surface of the current collector 11 is not made larger than H·tan ω. When the interval between the bumps 12 is increased, the amount of the active material deposited in an area (dent) of the current collector 11 on which the bumps 12 are not formed is increased, and the width of the active material bodies 14′ is increased. As a result, the ratio of the space with respect to a layer (active material layer) 15′ which includes the plurality of active material bodies 14′ and the space 16′ is rather decreased.

Therefore, in order to increase the width of the space 16′, the height H of each bump 12 needs to be increased or the vapor deposition angle ω needs to be made closer to 90°. However, if the height H is increased, the thickness of the current collector 11 is increased. As a result, the volume of the current collector 11 with respect to the electrode is increased, which decreases the capacity. Therefore, it may be undesirably impossible to obtain a high energy density with certainty. It is not practical to make the vapor deposition angle ω closer to 90° because the productivity is drastically reduced. Therefore, it may be occasionally difficult to increase the ratio of the space 16′ with respect to the active material layer without decreasing the energy density or the adherence of the active material bodies.

By contrast, in this embodiment, as shown in FIG. 2(a), first, an active material layer 15a including a plurality of active material bodies 14 is formed by oblique vapor deposition. In the active material layer 15a, each active material body 14 is formed on the bump 12 and a space 16a is formed between adjacent active material bodies 14. Width Ea of the space 16a on the surface of the current collector 11 is H·tan ω as in the conventional electrode shown in FIG. 1.

Next, as shown in FIG. 2(b), the current collector 11 having the active material layer 15a formed thereon is stretched. Thus, an electrode 200 is obtained.

By the stretching step, an area of the current collector 11 on which the active material bodies 14 are not formed is elongated, and so the interval between the active material bodies 14 on the surface of the current collector 11 is increased. Therefore, in the post-stretching active material layer 15b, width Eb of a space 16b on the surface of the current collector 11 is larger than the width of the space 16a of the pre-stretching active material layer 15a. The width Eb of the space 16b can be made larger than the length determined by the height H of the bump 12 and the vapor deposition angle ω, namely, can be larger than H·tan ω.

Moreover, areas of the current collector at which the bumps 12 are formed, namely, areas on which the active material bodies 14 are formed, are thicker than the area of the current collector 11 which is a dent and on which the active material bodies 14 are not formed, and so are unlikely to be elongated by the stretching step. Therefore, with the method in this embodiment, the space 16b between the active material bodies 14 can be enlarged without increasing the width of the active material bodies 14. As a result, the ratio of the space 16b with respect to the active material layer 15b can be increased as compared with in the conventional electrode.

Now, with reference to the figures, the method for producing an electrode in this embodiment will be described more specifically.

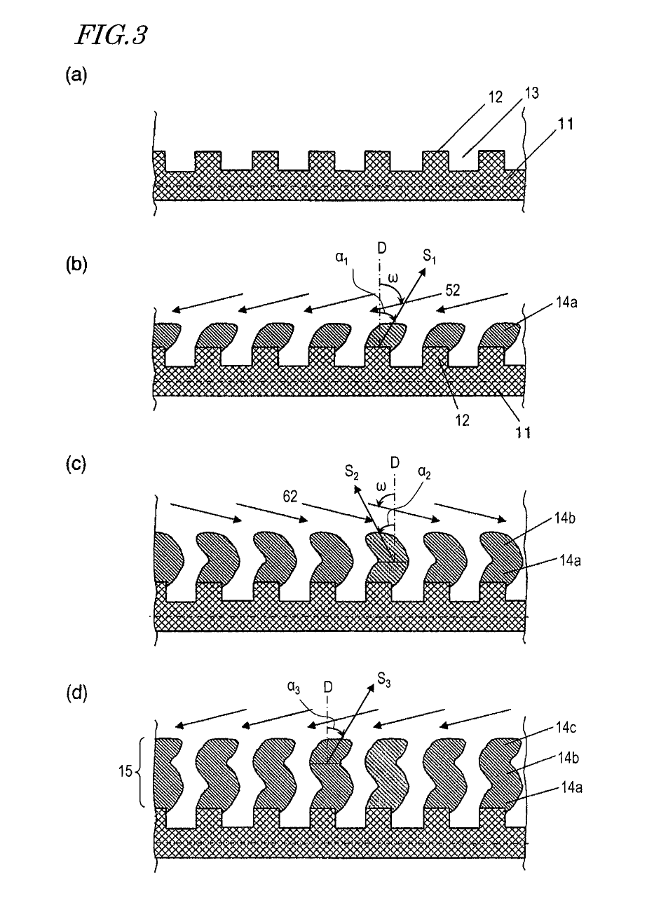

FIGS. 3(a) through (d) are schematic views for illustrating stages of the vapor deposition step in this embodiment. Herein, the vapor deposition is performed a plurality of times while the vapor deposition direction is alternately inverted with respect to the normal to the surface of the current collector. When the vapor deposition step is performed for first through n'th stages (n≧2) while the vapor deposition direction is changed, the obtained active material bodies each include n pieces of portions in accordance with the growth direction thereof. In this specification, the n pieces of portions will be referred to as the “first portion, second portion, . . . n'th portion” from the surface side of the current collector.

First, as shown in FIG. 3(a), the current collector 11 having a plurality of bumps 12 at the surface thereof is produced. The current collector 11 is obtained by, for example, transferring a concaved and convexed pattern on a copper foil using a roller used for a rolling method and having the concaved and convexed pattern formed at a surface thereof. The plurality of bumps 12 are regularly arranged with an interval held therebetween at the surface of the current collector 11. The expression “regularly arranged” indicates that the interval between adjacent bumps 12 is adjusted to be equal to, or greater than, a prescribed distance, and this concept does not encompass concaved and bumps formed at the surface by roughening. The plurality of bumps 12 do not need to be arranged at an equal interval. The bumps 12 do not need to have generally the same shape, and may be different in the width or the height.

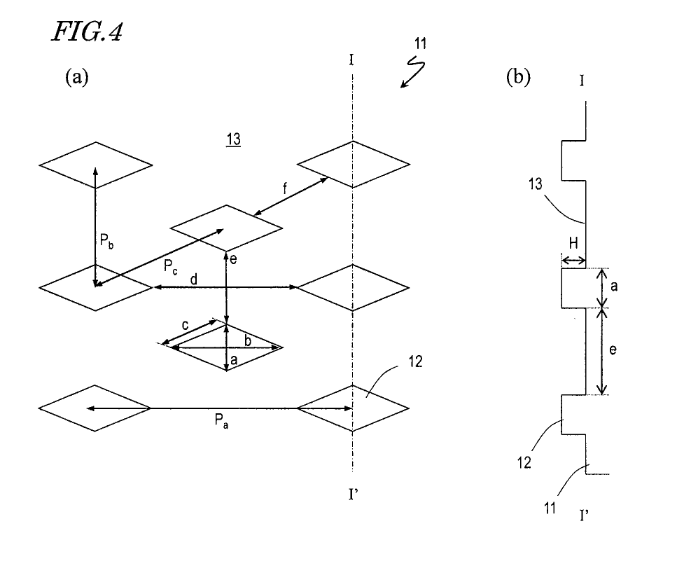

FIG. 4(a) is a schematic plan view showing an example of the bumps 12 of the current collector 11 in this embodiment, and FIG. 4(b) is a cross-sectional view taken along line I-I′ of FIG. 4(a). In the example shown here, the bumps 12 are each like a column having a rhombic top surface, and are arranged in a lattice (including houndstooth check) at the surface of the current collector 11. Preferable ranges of the height H and arrangement pitches Pa, Pb and Pc of the bumps 12, etc. will be described later.

Next, as shown in FIG. 3(b), a vaporized vapor deposition material (for example, silicon) is incident on the surface of the current collector 11 in the direction 52 inclined at a prescribed angle (hereinafter, referred to as the “vapor deposition angle”) ω with respect to the normal D to the surface of the current collector 11. As a result, a first portion 14a of the active material body containing silicon is formed on each bump 12 (first-stage vapor deposition step).

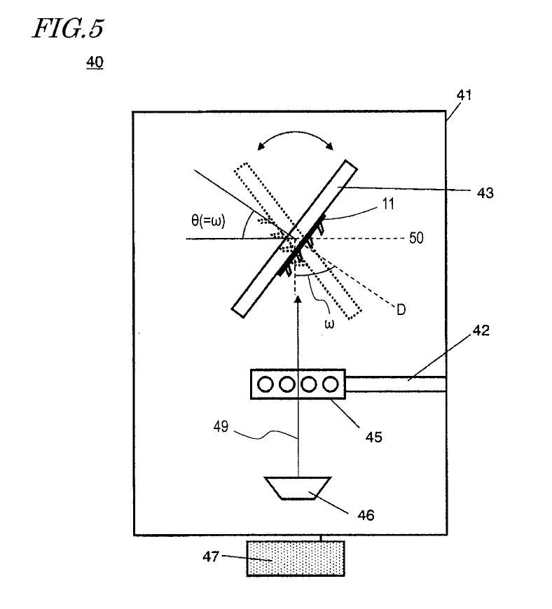

FIG. 5 is a schematic view showing an example of a structure of a vapor deposition device usable for forming the active material bodies. A vapor deposition device 40 includes a vacuum chamber 41 and an exhaust pump 47 for exhausting the vacuum chamber 41. Inside the vacuum chamber 41, a fixing table 43 for fixing the current collector 11, a gas introduction pipe 42 for introducing oxygen gas into the vacuum chamber 41, and a crucible 46 loaded with a vapor deposition source for supplying silicon to the surface of the current collector 11 are installed. As the vapor deposition source, silicon is usable, for example. Although not shown, electron beam heating means for vaporizing a material of the vapor deposition source is provided. The gas introduction pipe 42 includes an oxygen nozzle 45, and is located such that oxygen gas ejected from the oxygen nozzle 45 is supplied to the vicinity of the surface of the current collector 11. The fixing table 43 and the crucible 46 are located such that vapor deposition particles (herein, silicon atoms) 49 from the crucible 46 are incident on the surface of the current collector 11 in a direction having the angle (vapor deposition angle) ω with respect to the normal direction D to the current collector 11. In this example, the fixing table 43 has a rotation shaft. By rotating the fixing table 43 around the rotation shaft, angle θ of the normal to the fixing table 43 with respect to a horizontal face 50 is adjusted to be equal to the prescribed vapor deposition angle ω (for example, θ=65′). Herein, the term “horizontal face” refers to a face perpendicular to a direction in which the material of the vapor deposition source placed in the crucible 46 and directed toward the fixing table 43 after being gasified.

In this embodiment, vapor deposition (EB vapor deposition) is performed as follows. While oxygen gas is blown to the vicinity of the surface of the current collector 11 from the oxygen nozzle 45, silicon in the crucible 46 is dissolved by being irradiated with an electron beam (EB) provided by an electron gun (not shown) and thus is incident on the current collector 11. In this case, on the surface of the current collector 11, the silicon atoms 49 react with the oxygen gas and thus a silicon oxide is grown. On this stage, the silicon atoms 49 are incident on the surface of the current collector 11 in a direction inclined with respect to the normal D to the current collector 11, and so is easily vapor-deposited on the bumps 12 at the surface of the current collector 11. Thus, the silicon oxide is grown like columns only on the bumps 12. By contrast, on an area of the surface of the current collector 11 which is in the shadow of the silicon oxide growing like columns, the silicon atoms are not incident and so the silicon oxide is not vapor-deposited (shadowing effect). As a result, the active material (herein, a silicon oxide) is deposited like a column on each bump 12 of the current collector 11. Thus, the first portion 14a is obtained.

Growing direction S₁ of the first portion 14a is inclined at angle α₁ with respect to the normal direction D to the current collector 11. The inclining angle α₁ is determined by the vapor deposition angle (incidence angle of silicon) ω. Specifically, it is empirically known that the inclining angle α₁ of the growth direction and the vapor deposition angle ω of silicon fulfill the relationship of 2 tan α₁=tan ω. It is also known that by changing the amount of oxygen to be introduced and thus controlling the inner pressure of the vacuum tank, the inclining angle is decreased as compared with the inclining angle calculated based on the above-described relationship. Thus, the inclining angle α₁ can be controlled by changing the vapor deposition angle and the inner pressure of the vacuum tank.

The obtained first portion 14a has a chemical composition of SiOₓ. An average value of the molar ratio x of the amount of oxygen with respect to the amount of silicon in the first portion 14a, and the thickness of the first portion 14a, are controlled by adjusting the output at the time of vapor deposition, the time, the amount of oxygen gas to be introduced into the vacuum chamber 41 (namely, the concentration of oxygen in the atmosphere), and the like.

Next, as shown in FIG. 3(c), the vaporized vapor deposition material (herein, silicon) is incident on the surface of the current collector 11 in a direction 62 inclined oppositely to the vapor deposition direction 52 in the first-stage vapor deposition step. As a result, a second portion 14b is formed on each first portion 14a (second-stage vapor deposition step).

The second-stage vapor deposition step is also performed using the vapor deposition device shown in FIG. 5. Specifically, after the first-stage vapor deposition step, the fixing table 43 is rotated clockwise around the rotation shaft to be inclined in the opposite direction to the inclining direction of the fixing table 43 in the first-stage vapor deposition step with respect to the horizontal face 50 (for example, θ=−65′). After this, like the first-stage vapor deposition step, silicon in the crucible 46 is vaporized and incident on the first portion 14a on the current collector 11. In the cross-section shown here, the direction 62 in which the silicon atoms 49 are incident is inclined at, for example, 65° in the opposite direction to the direction 52 with respect to the normal D to the current collector 11 (ω=−65′). Like in the first-stage vapor deposition step, at the same time as the incidence of the silicon atoms 49, oxygen gas is supplied from the oxygen nozzle 45 toward the current collector 11. As a result, a silicon oxide (SiOₓ) is selectively deposited on the first portion 14a on the current collector 11, and thus the second portion 14b is obtained. In the cross-section shown here, growth direction S₂ of the second portion 14b is inclined at angle α₂ in the opposite direction to the growth direction of the first portion 14a with respect to the normal direction D to the current collector 11 (α₂=−α₁).

Then, as shown in FIG. 3(d), the angle θ of the fixing table 43 may be returned to the same angle as in the first-stage vapor deposition step (herein, 65°) to grow a silicon oxide in the same conditions as those of the first-stage vapor deposition step (third-stage vapor deposition step). As a result, a third portion 14c is further formed on the second portion 14b. Inclining angle α₃ of the third portion 14c in growth direction S₃ is the same as the inclining angle α₁ of the first portion 14a.

In this manner, vapor deposition is performed up to the n'th stage (n≧2) while the vapor deposition angle ω is alternately changed between, for example, 65° and −65°. As a result, an active material body including n pieces portions can be formed. In this embodiment, the vapor deposition is performed up to the 35th stage to obtain a plurality of active material bodies.

Then, the current collector having the active material bodies formed thereon is stretched in a direction parallel to the surface of the current collector. Herein, the current collector is stretched on a plane parallel to the surface of the current collector in a direction perpendicular to the vapor deposition direction.

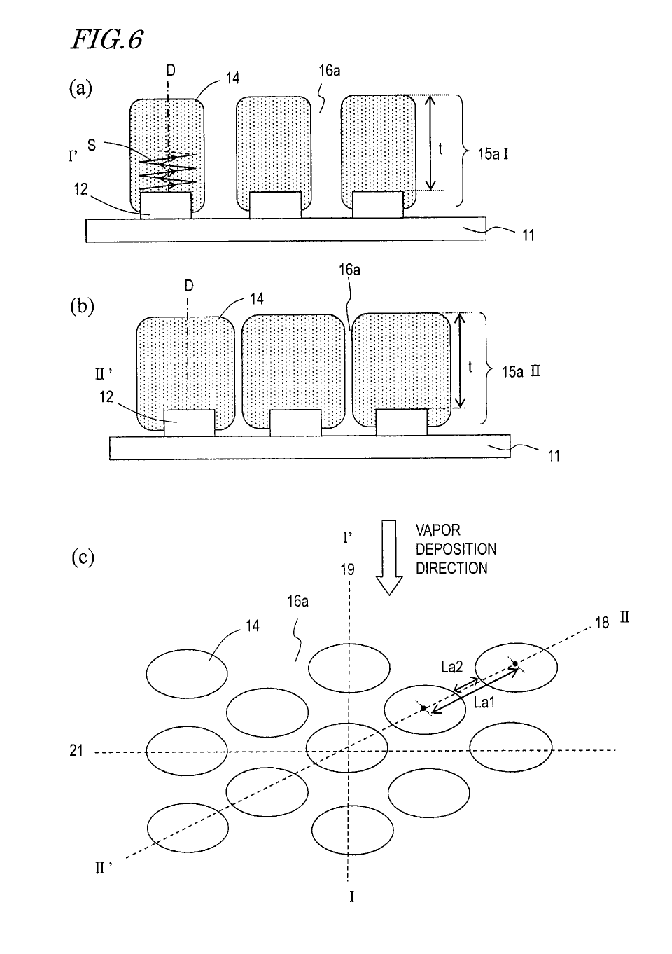

FIGS. 6(a), (b) and (c) schematically show the current collector after having the active material bodies formed thereon but before being stretched. FIG. 6(c) is a plan view, and FIGS. 6(a) and (b) are cross-sectional views respectively taken along line I-I′ and line II-II′ in FIG. 6(c).

As shown in FIG. 6(c), the plurality of active material bodies 14 obtained by the above-described vapor deposition step are arranged regularly in correspondence with the positions of the bumps 12 shown in FIG. 4. These active material bodies 14 do not contact each other, and a space 16a is existent between adjacent active material bodies 14. In this specification, a layer including the plurality of active material bodies 14 and the space 16 between adjacent active material bodies 14 will be referred to as the “active material layer 15a”.

Each active material body 14 may occasionally have a zigzag shape in correspondence with growth direction S, but herein, are like columns upright in the normal direction D to the current collector 11. In the case where, as in this embodiment, the vapor deposition step is performed in many stages, for example, 30 or more stages (n≧30) or the portion formed by each stage of the vapor deposition step has an especially small thickness (for example, 0.5 μm or less), the obtained active material bodies 14 are like upright columns. Even in this case, the growth direction S of the active material bodies 14 can be confirmed to be zigzag from a bottom surface to a top surface thereof by observing the cross-section of the active material bodies 14.

The active material bodies 14 may be formed of a one-stage vapor deposition step and have a shape inclined in one direction. However, it is preferable that the active material bodies 14 are formed of a multiple-stage vapor deposition step and each have a plurality of layers which are different in the growth direction S. Owing to such a structure, the stress applied on the current collector 11 by the expansion of the volume of the active material bodies 14 at the time when the active material bodies 14 occlude lithium ions can be more effectively alleviated.

As is seen from FIGS. 6(a) and (c), in the example shown here, the active material bodies 14 are arranged along a direction 19 parallel to the vapor deposition direction on a plane parallel to the surface of the current collector 11 while the space 16a, which is sufficiently large, is provided between adjacent active material bodies 14. By contrast, along a direction 18, as can be seen from FIGS. 6(b) and (c), the plurality of active material bodies 14 are closest to each other and the width of the space 16a between adjacent active material bodies 14 is smallest. In this manner, the direction 18 defines a distance La2 between each two active material bodies 14 which are closest to each other (minimum distance La2). The term “minimum distance” refers to the distance between adjacent active material bodies 14 on a plane parallel to the surface of the current collector 11 when the active material bodies 14 do not occlude lithium ions, namely, the minimum value of the width of the space between adjacent active material bodies 14.

Accordingly, in this embodiment, a linear void ratio in the direction 18 has the minimum value of the linear void ratio in an arbitrary direction (hereinafter, this minimum value will be referred to as the “minimum linear void ratio”). Herein, the “linear void ratio” is the ratio of the space 16 with respect to the active material layer 15a in an arbitrary direction (for example, directions 18, 19, 21, etc.) on a plane parallel to the surface of the current collector 11. For example, where the arrangement pitch of the active material bodies 14 in the direction 18 is La1, the linear void ratio in the direction 18 is represented by (La2/La1)×100(%). The minimum linear void ratio of the pre-stretching current collector 11 is preferably greater than 0% (namely, the active material bodies 14 do not contact each other), and is, for example, 0.5% or greater.

Next, the current collector 11 shown in FIG. 6 is supplied with a tensile load and is stretched in one axial direction. Herein, the current collector 11 is stretched in a direction 21 perpendicular to the vapor deposition direction on a plane parallel to the surface of the current collector 11. As a result, the length of the current collector 11 along the direction 21 is made larger than the length of the pre-stretching current collector 11 along the direction 21 (for example, 100.5% or greater) by plastic deformation. Thus, the electrode 200 is obtained.

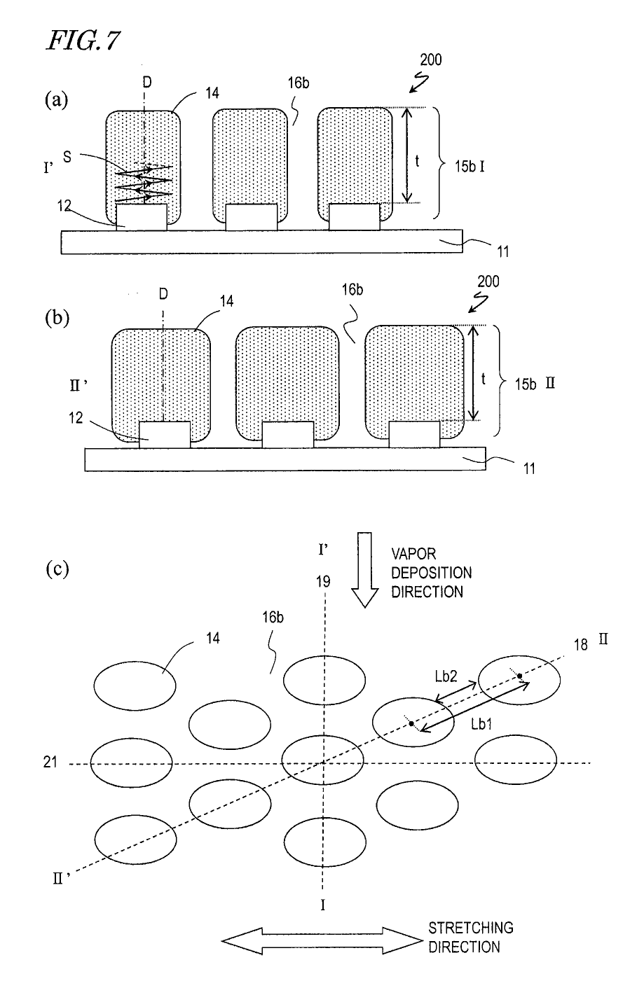

FIGS. 7(a), (b) and (c) schematically show the electrode 200. FIG. 7(c) is a plan view, and FIGS. 7(a) and (b) are cross-sectional views respectively taken along lines I-I′ and II-II′ in FIG. 7(c).

As is understood from FIGS. 7(b) and (c), the current collector 11 is plastically deformed in the direction 21 by the stretching step, and the space 16b between the active material bodies 14 is larger than the pre-stretching space 16a (FIG. 6). In this step, an area of the current collector 11 on which the active material bodies 14 are not formed, namely, the dent, is mainly elongated, whereas the areas on which the active material bodies 14 are formed are not elongated almost at all. In other words, the interval between the active material bodies 14 can be increased without increasing the width of the active material bodies 14 or making cracks in the active material bodies 14. Therefore, the linear void ratio of the electrode 200 in the direction 18 (minimum linear void ratio), i.e., (Lb2/Lb1)×100(%), is larger than the pre-stretching minimum linear void ratio, i.e., (La2/La1)×100(%).

As understood from this, in this embodiment, the ratio of the space 16b between the active material bodies 14 (linear void ratio) can be made larger than that provided by the conventional art, by stretching the current collector 11 after the active material bodies 14 are formed. For example, according to the conventional method described above with reference to FIG. 1, it is difficult to obtain a minimum linear void ratio of 10% or greater while keeping the productivity. According to the method in this embodiment, the minimum linear void ratio of 10% or greater can be more easily obtained without spoiling the productivity, for example, without increasing the height of the bumps 12 of the current collector or increasing the vapor deposition angle ω.

Accordingly, a space sufficiently large for alleviating the expansion and contraction of the active material bodies 14 can be obtained with more certainty. Also in this embodiment, a cell is produced using an electrode already stretched. Therefore, the current collector can be suppressed from being elongated by charge/discharge of the cell, and so the deformation of the electrode such as generation of wrinkles can be suppressed. Thus, the deformation of the cell due to the expansion and contraction of the active material bodies 14 can be suppressed, and the charge/discharge cycle characteristic can be improved.

In the stretching step in this embodiment, it is sufficient to stretch the current collector 11 having the active material layer 15a at least in one axial direction on a plane parallel to the surface of the current collector 11. There is no specific limitation on the method of stretching, but it is preferable to apply a load uniformly in the stretching direction. In the case where a sheet-like current collector is used, for example, while the current collector having the active material layer is fed out from one of the rollers and wound around the other roller, a load is applied between the two rollers. In this manner, the current collector can be stretched in a longitudinal direction (MD direction) of the current collector. Alternatively, the current collector having the active material layer may be fed out and wound around the roller in the state where a tensile load is applied on the current collector in a direction perpendicular to the MD direction (width direction of the current collector; hereinafter, referred to as the “TD direction”). In this case, the current collector is stretched in the TD direction.

The current collector 11 may be stretched in two axial directions on a plane parallel to the surface of the current collector 11. For example, a tensile load may be applied in two axial directions perpendicular to each other (for example, the MD direction and the TD direction) at the same time or sequentially to stretch the current collector 11. Alternatively, the current collector 11 having the active material layer 15a may be rolled to be stretched. A device usable for this method will be described later.

There is no specific limitation on the direction of stretching the current collector 11, but it is preferable that the current collector 11 is stretched so as to enlarge the space 16a between the active material bodies 14. Especially where the current collector 11 is stretched so as to enlarge the minimum distance between adjacent active material bodies 14, the stress applied on the current collector 11 by contact between the active material bodies 14 can be effectively reduced.

It is preferable to stretch the current collector such that the length of the post-stretching current collector 11 in the stretching direction is 100.5% or greater of the length of the pre-stretching current collector 11 in the stretching direction owing to plastic deformation. A reason for this is that by plastically deforming the current collector 11 so as to have a length which is 100.5% or greater of the pre-stretching length, a space which is sufficiently large to alleviate the stress generated by the expansion and contraction can be formed between adjacent active material bodies 14. Herein, the term “plastic deformation” means deformation which is caused by a load exceeding the elastic limit of the material and is kept without returning to the original shape even after the load is removed. The “plastic deformation” does not encompass elastic deformation. Accordingly, the expression “stretching the current collector 11 by plastic deformation” means that the current collector 11 is deformed by applying a tensile load thereto and is kept stretched even after the tensile load is removed.

An elongation ratio (rupture elongation ratio) of the pre-stretching current collector 11 is preferably 1.0% or greater. The “elongation ratio (rupture elongation ratio)” refers to the elongation ratio obtained at the time when the current collector 11 is ruptured by a tensile test. When the current collector 11 has a rupture elongation ratio of 1.0% or greater, the current collector 11 can be easily stretched by 0.5% or greater without being broken.

Before being stretched, the current collector 11 may be annealed. Owing to the annealing, the rupture elongation ratio of the current collector 11 can be increased, and so the current collector 11 is easier to be elongated. Annealing is not indispensable regardless of the type of the current collector 11, but annealing provides the effect of the present invention with more certainty. For example, in the case where the current collector 11 is formed using a rolled copper foil, the rolled copper foil has a low rupture elongation ratio but can be sufficiently elongated by being annealed before being stretched. Therefore, a sufficiently large space can be formed in the active material layer with more certainty. There is no specific limitation on the conditions of annealing, and conditions of annealing are appropriately selectable in accordance with the material of the current collector 11 or the like.

The minimum linear void ratio (post-stretching minimum linear void ratio) of the active material layer 15b of the electrode 200 in this embodiment can be controlled by appropriately selecting the location and the size of the bumps 12 formed at the surface of the current collector 11, the vapor deposition conditions for forming the active material bodies 14, and the stretching conditions (the stretching direction, the magnitude of the tensile load, etc.). When the minimum linear void ratio of the electrode 200 obtained after the stretching is 5% or greater, an effect of suppressing the deformation of the electrode plate is provided. More preferably, the minimum linear void ratio is 8% or greater. With such values, the contact between the active material bodies 14 is suppressed with more certainty. From the viewpoint of obtaining a certain level of charge capacity, the minimum linear void ratio is preferably 30% or less. More preferably, the average value of the linear void ratio in an arbitrary direction is 20% or less. With such values, a large charge capacity can be realized with more certainty.

In this specification, the terms “linear void ratio” and “minimum linear void ratio” respectively mean the average linear void ratio and the average minimum linear void ratio of the active material layer 15b after the electrode 200 is produced but before lithium is occluded. The linear void ratio and the minimum linear void ratio before lithium is occluded or after charge/discharge are found by, for example, observing a top surface of the active material layer 15b using a scanning electron microscope (SEM).

The electrode 200 is stretched in advance, and so is unlikely to be deformed, for example, wrinkled, by charge/discharge of the cell. Even in a cell using a conventional electrode which is not stretched in advance, the electrode is stretched on a plane parallel to the current collector by charge/discharge of the cell. However, a portion of the current collector on which the active material layer is not formed (a portion to which the lead is connected, etc.) is not elongated almost at all. By contrast, in a cell using the electrode 200 in this embodiment, even a portion of the current collector on which the active material layer is not formed is stretched. Accordingly, in order to determine whether the electrode has been stretched or not during the production thereof, the elongation of the portion to which the lead is connected, for example, may be checked in addition to whether or not the electrode is wrinkled or not after the charge/discharge.

Now, with reference to the figures, preferable locations and sizes of the bumps 12 of the pre-current collector 11 in this embodiment will be described.

FIGS. 4(a) and (b) will be referred to again. In the example shown here, the bumps 12 are each like a column having a rhombic top surface. However, the shape of the bump 12 is not limited to this. An orthogonal projection image of the bump 12 as seen in the normal direction D to the current collector 11 may be square, rectangular, trapezoidal, rhombic, parallelogramic, pentagonal, polygonal such as home plate-shaped, circular, elliptical or the like. The shape of the cross-section of the bump 12 parallel to the normal direction D to the current collector 11 may be square, rectangular, polygonal, semicircular, or a combination thereof. The shape of the bump 12 along a cross-section perpendicular to the surface of the current collector 11 may be, for example, polygonal, semicircular, bow-shaped or the like. In the case where the border between the bump 12 and a portion other than the bump 12 (also referred to as the “groove”, “dent” or the like) is not clear, for example, in the case where the cross-section of the concaved and convexed pattern formed at the current collector 11 has a curved shape, among the entire surface having the concaved and convexed pattern, a portion above the line of the average height will be referred to as the “bump 12” and a portion below the line of the average height will be referred to as the “groove” or the “dent”. The “dent” may be a single continuous area as in the example shown here or a plurality of areas separated from each other by the bumps 12. In this specification, the “interval between adjacent bumps 12” means a distance between adjacent bumps 12 on a plane parallel to the surface of the current collector 11 and is the “width of the groove” or the “width of the dent”.

The height H of the bump 12 is preferably 3 μm or greater, more preferably 4 μm or greater, and still more preferably 5 μm or greater. When the height H is 3 μm or greater, the active material body 14 can be located only on the bump 12 by oblique vapor deposition using the shadowing effect. Therefore, the space 16 can be formed between the active material bodies 14 with certainty. The height H of the bump 12 is preferably 15 μm or less, and more preferably 12 μm. When the bump 12 is 15 μm or less, the volume ratio of the current collector 11 with respect to the electrode can be suppressed low. Therefore, a high energy density can be obtained.

The bumps 12 are preferably arranged regularly at a prescribed arrangement pitch. For example, the bumps 12 may be arranged in a houndstooth check-like or grid-like pattern. The arrangement pitch of the bumps 12 (distance between the centers of adjacent bumps 12) is, for example, 10 μm or greater and 100 μm or less. Herein, the “center of the bump 12” refers to the central point of the maximum width of the top surface of the bump 12. When the arrangement pitch is 10 μm or greater, a space for allowing the active material body 14 to expand can be formed between adjacent bumps 12 with certainty. The arrangement pitch is preferably 20 μm or greater, and more preferably 30 μm or greater. When the arrangement pitch P is 100 μm or less, a large capacity can be obtained certainly without increasing the height of the active material body 14. The arrangement pitch P is preferably 80 μm or less, more preferably 60 μm or less, and still more preferably 50 μm or less. In the example shown here, the bumps 12 are arranged along three directions, and all of arrangement pitches Pa, Pb and Pc in the respective directions are preferably in the above ranges.

The ratio of interval d between the bumps 12 with respect to the arrangement pitch Pa of the bumps 12 is preferably ⅓ or greater and ⅔ or less. Similarly, the ratio of interval e between the bumps 12 with respect to the arrangement pitch Pb of the bumps 12, and the ratio of interval f between the bumps 12 with respect to the arrangement pitch Pc of the bumps 12, are each preferably ⅓ or greater and ⅔ or less. When the ratio of each of these intervals d, e and f is ⅓ or greater, the width of the space between the active material bodies 14 formed on the bumps 12 in each arrangement direction can be obtained with more certainty. Therefore, a sufficiently high linear void ratio is obtained. When the ratio of each of these intervals d, e and f is ⅔ or greater, the active material is vapor-deposited also on the groove between the bumps 12, and so the stress applied on the current collector 11 by the expansion of the active material may be undesirably increased.

The width of the top surface of the bump 12 is preferably 200 μm or less, and more preferably 50 μm or less. With such values, a sufficiently large space can be obtained with certainty between the active material bodies 14 using the shadowing effect. Therefore, the deformation of the electrode 200 due to the stress generated by the expansion of the active material can be effectively suppressed. By contrast, when the width of the top surface of the bump 12 is too small, a sufficiently large size of contact area between the active material body 14 and the current collector 11 may not be obtained. Therefore, the width of the top surface of the bump 12 is preferably 1 μm or greater. Especially where the bump 12 is column-like, when the width of the top surface thereof is too small (for example, less than 2 μm), the bump 12 is too thin and so is easy to be deformed by the stress generated by charge/discharge. Therefore, the width of the top surface of the bump 12 is more preferably 2 μm or greater. With such values, the deformation of the bump 12 due to charge/discharge can be suppressed with more certainty. In the example shown here, all of widths a, b and c of the bump 12 in the respective arrangement directions are preferably in the above ranges.

In the case where the bump 12 is like a column having a side surface perpendicular to the surface of the current collector 11, the intervals d, e and f between adjacent active material bodies 14 are preferably 30%, and more preferably 50%, of the widths a, b and c of the bump 12, respectively. With such values, a sufficiently large space can be obtained with certainty between the active material bodies 14 to significantly alleviate the stress generated by the expansion of the active material. By contrast, when the distance between adjacent bumps 12 is too large, the thickness of the active material layer 15a needs to be increased in order to obtain a certain level of capacity. Therefore, the intervals d, e and f are preferably 250% or less, and more preferably 200% or less, of the widths a, b and c of the bump 12, respectively.

The top surface of the bump 12 may be flat, but preferably is concaved and convexed. Surface roughness Ra thereof is preferably 0.1 μm or greater. Herein, the term “surface roughness Ra” refers to the “arithmetic average roughness Ra” defined by the Japanese Industrial Standards (JISB 0601-1994) and can be measured using, for example, a surface roughness meter or the like. When the surface roughness Ra of the top surface of the bump 12 is less than 0.1 μm, in the case where, for example, the plurality of active material bodies 14 are formed on the top surface of one bump 12, each active material body 14 has an excessively small width (column diameter) and so is easy to be destroyed at the time of charge/discharge. The surface roughness Ra is more preferably 0.3 μm or greater. With such values, the active material body 14 is more easily grown on the bump 12, and as a result, a sufficiently large space can be formed between the active material bodies 14 with certainty. By contrast, when the surface roughness Ra is too large (for example, exceeding 100 μm), the thickness of the current collector 11 is too thick and a high energy density is not obtained. Therefore, the surface roughness Ra is preferably, for example, 30 μm or less. The surface roughness Ra is more preferably 10 μm or less, and still more preferably 5.0 μm or less. Especially when the surface roughness Ra of the current collector 11 is in the range of 0.3 μm or greater and 5.0 μm or less, a sufficiently strong adherence between the current collector 11 and the active material bodies 14 is obtained with certainty. Therefore, the active material bodies 14 can be prevented from being peeled off.

The material of the current collector 11 is preferably, for example, copper or a copper alloy obtained by rolling or electrolysis, and more preferably a copper alloy having a relatively high strength. In this embodiment, there is no specific limitation on the material of the current collector 11, but the current collector 11 is obtained by, for example, forming a regular concaved and convexed pattern including a plurality of bumps 12 at a surface of a metal foil of copper, a copper alloy, titanium, nickel, stainless steel of the like. As the metal foil, for example, a rolled copper foil, a rolled copper alloy foil, an electrolyzed copper foil, an electrolyzed copper alloy foil and the like are preferably usable.

There is no specific limitation on the thickness of the metal foil before the concaved and convexed pattern is formed. For example, the thickness is preferably 1 μm or greater and 50 μm or less. When the thickness is 50 μm or less, the current collector is sufficiently thin. Therefore, the ratio of the active material with respect to the electrode is sufficiently high and the capacity per unit volume can be increased. When the thickness is 1 μm or greater, the current collector 11 is easy to be handled. The thickness of the metal foil is more preferably 6 μm or greater and 40 μm or less, and still more preferably 8 μm or greater and 33 μm or less.

There is no specific limitation on the method for forming the bumps 12. For example, the metal foil may be etched using a resist resin or the like to form a groove having a prescribed pattern. Portions in which the groove is not formed may be set as the bumps 12. Alternatively, a resist pattern may be formed on the metal foil, and the bumps 12 may be formed on a groove of the resist pattern by electrodeposition or plating. Still alternatively, a groove formed by pattern carving in a roller usable used a rolling method may be mechanically transferred onto the surface of a metal foil.

As described above, the active material body 14 in this embodiment grows along the direction S inclined with respect to the normal direction D to the current collector 11. An angle (inclining angle) α made by the growth direction S of the active material body 14 and the normal direction D is preferably 5° or greater and more preferably 10° or greater. In order to obtain a good adherence, it is preferable that the contact area size between the active material body 14 and the current collector 11 is larger, namely, the inclining angle is 0°. However, in this case, the shadowing effect is not provided, and so no space can be formed between adjacent active material bodies 14. When the angle is 5° or greater, a space is formed between the active material bodies 14 and also a sufficiently large size of contact area is obtained. The inclining angle α is preferably less than 90°, but as the angle is closer to 90°, the vapor deposition ratio is lower. In consideration of the productivity, the inclining angle is preferably 80° or less. In the case where the active material body 14 is formed by oblique vapor deposition, the inclining angle α of the active material body 14 is determined by the vapor deposition angle at which the active material body 14 is formed. The inclining angle α can be found by, for example, measuring inclining angles of any two to 10 active material bodies 14 and calculating an average value thereof.

The inclining angle α of the active material body 14 may change in accordance with the height of the active material body 14. In the case where, as in this embodiment, the active material body 14 includes a plurality of portions which are different in the growth direction S, it is preferable that all the growth directions S of the active material body 14 are inclined with respect to the normal direction D, and that all the inclining angles α are 10° or greater and less than 90°.

In this embodiment, the area size ratio of the space 16b with respect to the active material layer 15b (hereinafter, referred to as the “planar void ratio”) is preferably 5% or greater and 50% or less. When the planar void ratio is 5% or greater, the expansion and contraction of the active material bodies 14 can be effectively accommodated in the space 16b. Therefore, the deformation of the electrode 200 can be reduced. From the viewpoint of obtaining a large capacity with certainty, the planar void ratio is preferably 50% or less. In the case where each active material body 14 is like a column upright along the normal D to the surface of the current collector 11, the planar void ratio is calculated by finding an area size of the active material layer 15b and an area size of the space 16b as seen from the normal D to the surface of the current collector 11. In the case where each active material body 14 is like a column inclining in one direction or a zigzag column, the planar void ratio is calculated by finding an area size of the active material layer 15b and an area size of the space 16b in a cross-section parallel to the surface of the current collector 11.

Thickness t of the active material layer 15b is the distance t, along the normal direction to the current collector 11, from the top surface of the bump 12 of the current collector 11 to the apex of the active material body 14. The thickness t is equal to the height of the active material body 14. The thickness t is, for example, 0.01 μm or greater and preferably 0.1 μm or greater. In this case, a sufficiently high energy density can be obtained with certainty, and so the characteristic having a large capacity of the active material containing silicon can be well utilized. When the thickness t is 3 μm or greater, the volume ratio of the active material with respect to the entire electrode is larger, and so a still higher energy density is obtained. The thickness t is more preferably 5 μm or greater, and still more preferably 8 μm or greater. The thickness t of the active material layer 15b is, for example, 100 μm or less, preferably 50 μm or less, and more preferably 40 μm or less. With such values, the stress generated by the expansion of the active material layer 15b can be suppressed. The above ranges of thickness t are advantageous for high-rate charge/discharge because the resistance against the current collection can be made low. When the thickness t is, for example, 30 μm or less and more preferably 25 μm or less, the deformation of the current collector 11 due to the stress generated by the expansion of the active material can be suppressed more effectively.

The thickness t of the active material layer 15b can be measured by, for example, the following method. First, the entire thickness of the electrode 200 after the active material layer 15b is formed is measured. In the case where the bumps 12 and the active material layer 15b are formed only on one surface of the current collector 11, the thickness t of the active material layer 15 is found by subtracting the thickness of the current collector 11 including the bumps 12 (sum of the thickness of the metal foil and the height of the bumps 12) from the entire thickness of the electrode 200. In the case where the bumps 12 and the active material layers 15b are formed on both surfaces of the current collector 11, the total thickness of the active material layers 15b formed on both surfaces of the current collector 11 is found by subtracting the thickness of the current collector 11 including the bumps 12 (sum of the thickness of the metal foil and the total thickness of the bumps 12 formed on both surfaces thereof) from the entire thickness of the electrode 200.

There is no specific limitation on the width of the active material body 14. In order to prevent the active material body 14 from cracking due to the expansion thereof at the time of charge, the width of the active material body 14 is preferably 100 μm or less and more preferably 50 μm or less. In order to prevent the active material body 14 from being peeled off from the current collector 11, the width of the active material body 14 is preferably 1 μm or greater. The width of the active material body 14 is obtained as an average value of the widths, of any two to 10 active material bodies 14, along a cross-section which is parallel to the surface of the current collector 11 and which is at a level corresponding to ½ of the height t of the active material bodies 14. In the case where the cross-section is circular, the width of the active material body 14 is an average value of the diameters of such active material bodies 14.

In this embodiment, the capacity per unit area size of the active material layer 15b is preferably 2 mAh/cm² or greater. With such values, a high cell energy can be obtained. When the capacity per unit area size is increased while the linear void ratio is kept at 5% or greater, the thickness of the active material layer 15b (height of the active material body 14) t is increased and the amount of expansion of the active material at the time of charge is increased. As a result, there is an undesirable possibility that the deformation of the current collector 11 due to the stress generated by the expansion of the active material cannot be sufficiently suppressed. Therefore, the capacity per unit area size is preferably 10 mAh/cm² or less and more preferably 8 mAh/cm² or less.

The active material layer 15b in this embodiment preferably contains silicon element or tin element. With these elements, a large capacity can be obtained with certainty. More preferably, the active material layer 15b contains silicon element. The active material layer 15b may contain at least one selected from the group consisting of, for example, single element of silicon, a silicon alloy, a compound containing silicon and oxygen, and a compound containing silicon and nitrogen. The active material layer 15b may contain only one of, or two or more of, the above-listed substances.

The compound containing silicon and nitrogen may further contain oxygen. For example, the active material layer 15b may be formed of a plurality of compounds containing silicon, oxygen and nitrogen at different molar ratios. Alternatively, the active material layer 15b may be formed of a composite of a plurality of silicon oxides having different molar ratios of silicon and oxygen.

More preferably, the active material layer 15b contains a silicon oxide (SiOₓ, where 0<x<2). Generally in an active material containing a silicon oxide, as the molar ratio x of the amount of oxygen with respect to the amount of silicon (hereinafter, also referred to simply as the “oxygen ratio”) is lower, a larger charge/discharge capacity is obtained but the volume expansion ratio due to charge is higher. By contrast, as the oxygen ratio x is higher, the volume expansion ratio is suppressed but the charge/discharge capacity is decreased. When the average value of the oxygen ratio x is greater than 0, the expansion and contraction due to charge/discharge is suppressed and so the stress applied on the current collector 11 by the expansion of the active material can be suppressed. When the average value of the oxygen ratio x is less than 1.5, a sufficient charge/discharge capacity can be obtained with certainty, and the high-rate charge/discharge characteristic can be maintained. Thus, a good charge/discharge cycle characteristic and a high reliability can be realized.

Among portions having different growth directions, the oxygen ratios may be different. Even in such a case, the average value of the oxygen ratio x of the entire active material layer 15b is acceptable at 0<x<2 and is preferable at 0<x<1.5.

In this specification, the “average value of the molar ratio x of the amount of oxygen with respect to the amount of silicon” of the active material layer 15b indicates a value of a composition excluding lithium supplemented to, or occluded by, the active material layer 15b. It is sufficient that the active material layer 15b contains a silicon oxide having the above range of oxygen ratio, and may contain impurities such as Fe, Al, Ca, Mn, Ti or the like.

Now, with reference to the figures, an example of a lithium ion secondary battery including the electrode 200 in this embodiment as a negative electrode will be described.

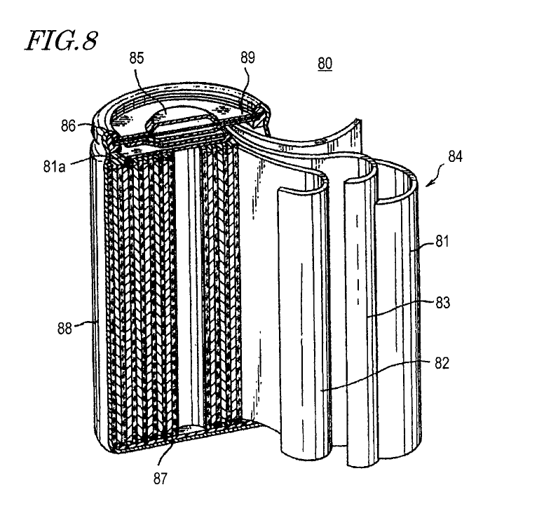

FIG. 8 is a schematic cross-sectional view of a cylindrical cell using the electrode 200 in this embodiment. The cylindrical cell 80 includes a cylindrical electrode assembly 84 and a cell can 88 for accommodating the electrode assembly 84. The electrode assembly 84 is obtained by winding a strip-like positive electrode plate 81 and a strip-like negative electrode plate 82 together with a wide separator 83 located therebetween. Although not shown, the positive electrode plate 81 includes a positive electrode current collector and a positive electrode active material layer formed on the positive electrode current collector, and the negative electrode plate 82 includes a negative electrode current collector and a negative electrode active material layer formed on the negative electrode current collector. The negative electrode plate 82 has, for example, a structure substantially the same as that of the electrode 200 described above with reference to FIGS. 7(a) and (b). The negative electrode plate 82 and the positive electrode plate 81 are located such that the negative electrode active material layer and the positive electrode active material layer face each other while having the separator 83 therebetween.

The electrode assembly 84 is impregnated with an electrolyte (not shown) for conducting lithium ions. An opening of the cell can 84 is closed by a sealing plate 89 having a positive electrode terminal 85. An end of a positive electrode lead 81a formed of aluminum is connected to the positive electrode plate 81, and the other end of the positive electrode lead 81a is connected to a rear surface of the sealing plate 89. Along a perimeter of the sealing plate 89, an insulating packing 86 formed of polypropylene is located. An end of a negative electrode lead (not shown) formed of copper is connected to the negative electrode plate 82, and the other end of the negative electrode lead is connected to the cell can 88. A top insulating ring (not shown) and a bottom insulating ring 87 are respectively located above and below the electrode assembly 84.

In the lithium ion secondary battery 80, the positive electrode active material layer releases lithium ions at the time of charge, and occludes lithium ions, released by the negative electrode active material layer, at the time of discharge. The negative electrode active material layer occludes the lithium ions, released by the positive electrode active material layer, at the time of charge, and releases the lithium ions at the time of charge.

In this embodiment, there is no specific limitation on the structural elements of the lithium ion secondary battery 80 other than the negative electrode plate 82. For example, the positive electrode active material layer may be formed of a lithium-containing transfer metal oxide such as lithium cobalt oxide (LiCoO₂), lithium nickel oxide (LiNiO₂), lithium manganese oxide (LiMn₂O₄) or the like, but is not limited to this. The positive electrode active material layer may be formed only of a positive electrode active material, or may be formed of a compound containing a positive electrode active material, a binder and a conductor. The positive electrode active material layer may include a plurality of active material bodies like the negative electrode active material layer. For the positive electrode current collector, it is preferable to use metal such as Al, an Al alloy, Ti or the like.

For the lithium ion-conductive electrolyte, any of various lithium ion-conductive solid electrolytes and non-aqueous electrolytic solutions is usable. A preferable non-aqueous electrolytic solution is a solution of a lithium salt dissolved in a non-aqueous solvent. There is no specific limitation on the composition of the non-aqueous electrolytic solution. There is no specific limitation on the separator or the external case, and any material usable for various forms of lithium secondary batteries is usable with no specific limitation. Instead of the separator, a lithium ion-conductive solid electrolyte, or a gel electrolyte containing such a solid electrolyte, is usable.

FIG. 8 shows one example of a cylindrical cell including a wound-type electrode plate assembly, but the present invention is also applicable to a wound-type polygonal cell or a laminate-type cell such as a coin-shaped cell or the like. The laminate-type cell may have a structure in which the positive electrode and the negative electrode are laminated in three or more layers. It is preferable that a positive electrode having a positive electrode active material layer on both or one of surfaces thereof and a negative electrode having a negative electrode active material layer on both or one of surfaces thereof are used, such that all the positive electrode active material layers face the negative electrode active material layers and all the negative electrode active material layers face the positive electrode active material layers. In the case where a plurality of negative electrode active material layers are included, the inclining state of the active material bodies (growth direction, number n of stages of vapor deposition, growth direction of a portion obtained by each vapor deposition stage, or the like) may be the same in, or different among, all the negative electrode active material layers. In one negative electrode active material layer, active material bodies having different inclining states may be formed. In the case where the negative electrode active material layers are formed on both surfaces of the negative electrode current collector, the inclining states of the active material bodies in the negative electrode active material layers may be the same as, or different from, each other.

As described above, there is no specific limitation on the structural elements of the lithium secondary battery according to the present invention except that the electrode according to the present invention is used as a negative electrode or a positive electrode. Any of various materials generally used as materials for lithium ion cells is selectable to be used.

### Example 1 and Comparative Example

Hereinafter, Example 1 according to the present invention and a comparative example will be described. Herein, an electrode 1 was produced in Example 1 and an electrode A was produced in the comparative example. The void ratio of the active material layer in each electrode was measured.

(i) Method for Producing the Electrode

(i-1) Electrode 1

<Production of the Current Collector>

First, a method for producing the current collector used in the electrode 1 will be described.

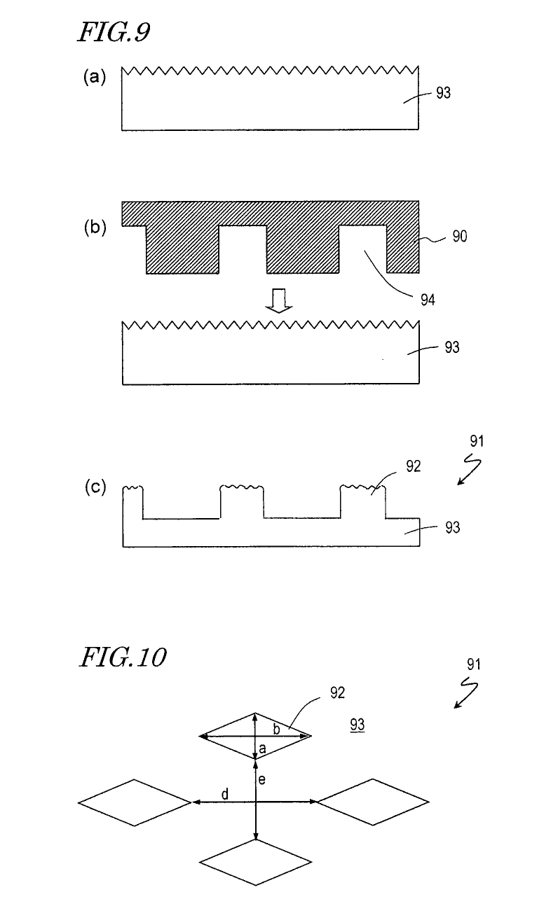

Both surfaces of a copper foil having a thickness of 27 μm (HCL-02Z, produced by Hitachi Cable, Ltd.) were roughened by electrolytic plating to form copper particles having a particle diameter of 1 μm. Thus, as shown in FIG. 9(a), a roughened copper foil 93 having a surface roughness Rz of 1.5 μm was obtained. The surface roughness Rz refers to the ten-point average roughness Rz defined by the Japanese Industrial Standards (JISB 0601-1994). Alternatively, a roughened copper foil commercially available for printed circuit boards may be used.

Next, as shown in FIG. 9(b), a plurality of grooves (dents) 94 were formed in a ceramic roller 90 using laser carving. The plurality of grooves 94 were formed to be rhombic as seen in the normal direction to the ceramic roller 90. The lengths of the diagonal lines of the rhombic shape were 10 μm and 20 μm, the interval between adjacent dents 94 along a diagonal line a was 18 μm, and the interval between adjacent dents 94 along a diagonal line b was 20 μm. The depth of each dent 94 was 10 μm. The copper foil 93 was rolled by passing the copper foil 93 between this ceramic roller 90 and another roller (not shown), located so as to face the ceramic roller 90, at a linear pressure of 1 t/mm.

In this manner, as shown in FIG. 9(c), a current collector 91 having a plurality of bumps 92 at a surface thereof was obtained. In this step, areas of the copper foil 93, passed between the rollers, which were pressed by a portion of the ceramic roller 90 other than the dents 94 were flattened as shown in the figure. By contrast, areas of the copper foil 93 corresponding to the dents 94 were not flattened and entered the dents 94, and as a result, the bumps 92 were formed. The height of the bumps 92 was about 6 μm, which was smaller than the depth of the dents 94 of the ceramic roller 90.

FIG. 10 is a plan view of the current collector 91. As shown in the figure, the shape and the arrangement of the bumps 92 of the current collector 91 correspond to those of the dents 94 formed in the ceramic roller 90. Each bump 92 had a rhombic top surface, and the lengths a and b of the diagonal lines thereof were about 10 μm and about 20 μm. Interval e between adjacent bumps 92 along the diagonal line a was 18 μm, and interval d between adjacent bumps 92 along the diagonal line b was 20 μm.

<Vapor Deposition Step>

The current collector 91 obtained in the above-described method was set on the fixing table 43 located inside the vacuum chamber 41 described above with reference to FIG. 5. While oxygen gas having a purity of 99.7% was supplied to the vacuum chamber 41, EB vapor deposition was performed with silicon as the vapor deposition source using a vapor deposition unit (the vapor deposition source, the crucible and the electron beam generation device which are structured into a unit). In this step, the inside of the vacuum chamber 41 had an oxygen atmosphere having a pressure of 3.5 Pa. In order to vaporize silicon as the vapor deposition source, an electron beam generated by the electron beam generation device was deflected by a deflection yoke to radiate to the vapor deposition source. As the vapor deposition source, chips of the material generated when a semiconductor wafer is formed (scrap silicon; purity: 99.999%) were used.

For performing vapor deposition, the fixing table 43 was inclined such that the vapor deposition angle ω would be 65°. The first-stage vapor deposition step was performed in this state to form a first-stage portion (first portion) of the active material bodies was formed. The film formation rate of the first portion was set to about 8 nm/s., and the oxygen flow rate was set to 30 sccm. The height of the first portion was set to 0.4 μm. The vapor deposition was performed on a plane parallel to the surface of the current collector 91 in a direction parallel to the shorter diagonal line of the bumps 12.

Next, the fixing table 43 was rotated clockwise around the central shaft thereof to incline in the opposite direction to the inclining direction of the fixing table 43 in the first-stage vapor deposition step, namely, to incline at a vapor deposition angle ω of −65°. Vapor deposition was performed in this state at an oxygen flow rate of 25 sccm to form a second portion (second-stage vapor deposition step). Then, the inclining direction of the fixing table 43 was changed to the same direction as that in the first-stage vapor deposition step. Vapor deposition was performed in substantially the same manner at a vapor deposition angle ω of 65° and an oxygen flow rate of 20 sccm (third-stage vapor deposition step). The film formation was performed in this manner while the vapor deposition angle ω was alternately switched between 65° and −65° and the oxygen flow rate was decreased stepwise to 15 sccm to 10 sccm, 5 sccm and 10 sccm until the seventh stage and then oxygen was not introduced from the eighth to 35th stages. Thus, the active material bodies having a height of 14 μm were formed to obtain an active material layer (thickness t: 14 μm). The average value of the molar ratio x of the amount of oxygen with respect to the amount of silicon in the active material layer was 0.4.

Then, the current collector 91 was detached from the fixing table 43 and then set on the fixing table 43 again such that a surface opposite to the surface having the active material bodies formed thereon, namely, the rear surface, would be directed upward. Vapor deposition was performed on the rear surface of the current collector 91 by 35 stages in substantially the same manner to form an active material layer (thickness t: 14 μm) (not shown). In this manner, the active material layers were formed on both surfaces of the current collector 91.

<Stretching Step>

For performing the stretching step, the rupture strength and the rupture elongation ratio of the pre-stretching current collector 91 were first found.

The current collector 91 having the active material layers on both surfaces thereof was cut into a piece having a width of 15 mm and a length of 70 mm, and the piece of the current collector 91 was stretched in one axial direction by a tensile test until being ruptured. The stretching direction was a direction along the longer diagonal line b of the bumps 92, and the tensile rate was the minimum possible rate. As a result, the rupture strength was 11.2 N/mm, and the rupture elongation ratio (maximum elongation ratio) was 0.2%.

In order to make the current collector 91 more easily stretchable, the current collector 91 was annealed at 500° C. for 1 hour. The post-annealing current collector 91 was cut into a piece having a width of 15 mm and a length of 70 mm, and the piece was stretched in one axial direction by a tensile test until being ruptured. As a result, the rupture strength was 6.1 N/mm, and the rupture elongation ratio (maximum elongation ratio) was 8%.

From the above results, it was found that in order to prevent the current collector 91 from being ruptured during the stretching step, the post-annealing current collector 91 should be stretched at a ratio smaller than 8%, which is the rupture elongation ratio.

Therefore, in this example, the post-annealing current collector 91 was cut into a piece having a width of 15 mm and a length of 70 mm, and the piece was stretched in a direction along the longer diagonal line b of the bumps 92 using a tensile tester to stretch the length along the stretching direction by 5% by plastic deformation. Thus, the electrode 1 was obtained.

### Comparative Example

On both surfaces of a current collector substantially the same as in Example 1, active material layers were formed in substantially the same method as in Example 1, except that the current collector was not annealed or stretched. Thus, the electrode A in the comparative example was obtained.

<Results>

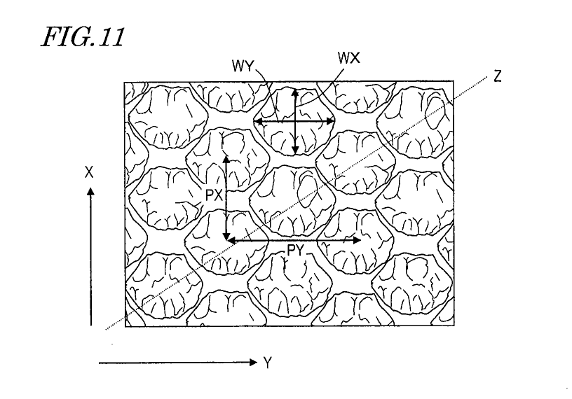

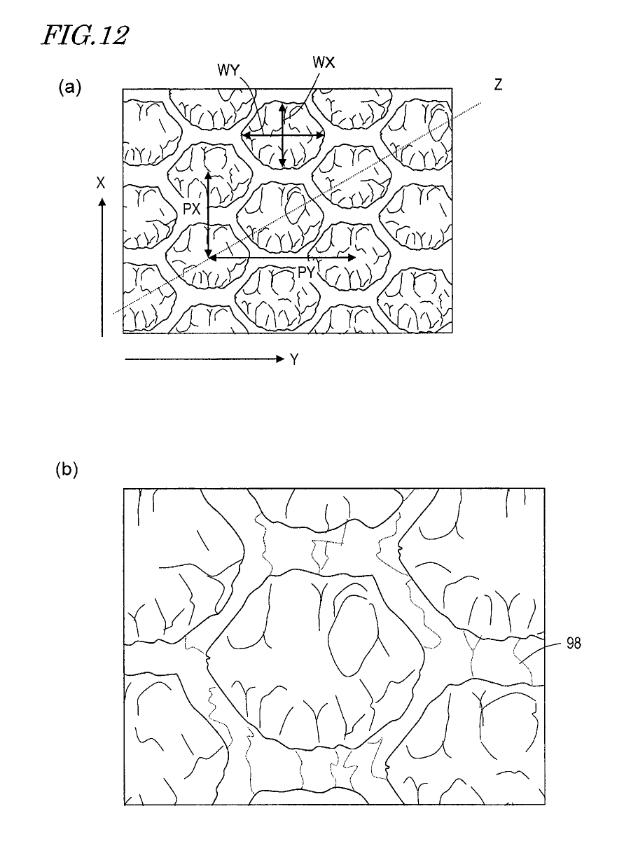

FIGS. 11 and 12(a) are schematic views respectively showing the results of the electrode A and the electrode 1 observed in the normal direction to the current collector using a scanning electron microscope. FIG. 12(b) is an enlarged view of FIG. 12(a). In FIGS. 11 and 12(a), X represents a direction parallel to the vapor deposition direction, and Y represents a direction perpendicular to the X direction. The X and Y directions are respectively parallel to the diagonal lines a and b (FIG. 10) of the current collectors 91.

From the top surfaces shown in FIGS. 11 and 12(a), the following sizes and ratios as seen in the normal direction to the current collector were found regarding the electrode A and the electrode 1: width WX of each active material body in the X direction, width WY of each active material body in the Y direction, arrangement pitch PX in the X direction, arrangement pitch PY in the Y direction, the linear void ratio (minimum linear void ratio) in a Z direction connecting the closest active material bodies, and the planar void ratio. The results are shown in Table 1.

TABLE 1

| | Electrode A | Electrode 1 |
|---|---|---|
| | (annealing: no; | (annealing: yes; |
| | stretching: no) | stretching: yes) |
| Width WX of active | 25.4 μm | 25.3 μm |
| material body | | |
| Width WY of active | 33.5 μm | 33.7 μm |
| material body | | |
| Arrangement pitch PX | 32.5 μm | 32.6 μm |
| Arrangement pitch PY | 49.5 μm | 59.2 μm |
| Linear void ratio in | 6.1% | 19.4% |
| Z direction | | |
| Planar void ratio | 21.3% | 31.9% |

From the results shown in Table 1, it is understood that by the stretching step, the widths WX and WY of each active material body were not elongated almost at all, but the arrangement pitch PY of the active material bodies was elongated by about 20% and thus the space between the active material bodies was enlarged in the Y direction. It is also understood that the minimum linear void ratio and the planar void ratio can be enlarged up to 19.4% and 31.9%, respectively.

Thus, it is understood that by performing the stretching step, the ratio of the space between the active material bodies can be increased and the stress generated by the expansion of the active material can be alleviated without reducing the productivity. The ratio of the space can be appropriately adjusted by changing a condition such as the tensile load or the like.

Referring to FIG. 12(b), on an area 98 of the current collector 91 which is not in contact with the active material bodies, the active material (a silicon oxide) is deposited in a small thickness. It is understood from FIG. 12(b) that there are breaking lines generated in this deposited layer by the stretching step. Many of the breaking lines are generated along the X direction perpendicular to the stretching direction. Therefore, even when the active material of the deposited layer is expanded, these breaking lines act as a space to reduce the stress applied on the current collector 91 by the expansion.

### Example 2

In Example 1 described above, the current collector was stretched in the Y direction. In Example 2, the current collector having active material layers formed thereon was stretched by rolling, and thus an electrode 2 was produced.

First, on both surfaces of a current collector substantially the same as in Example 1, active material layers were formed in substantially the same manner as in Example 1. Then, in substantially the same manner as in Example 1, the current collector was annealed at a temperature of 500° C. for 1 hour in an argon atmosphere. The post-annealing current collector was cut into a piece having a width of 15 mm and a length of 70 mm.

Then, this current collector having the active material layers formed thereon was stretched on a plane parallel to the current collector. The stretching of the current collector was performed by rolling using stretchable rubber.

FIG. 13 is a schematic cross-sectional view for illustrating the stretching step (rolling) performed in Example 2. As shown in the figure, a current collector 100 (15 mm×70 mm) having the active material layers formed thereon was held between two rubber plates 63 having a thickness of 1.0 mm and pressurized in a thickness direction via the plates 63. In this example, as the stretchable rubber for the plates 63, silicone rubber SR50 produced by Tigers Polymer Corporation was used. Thus, the current collector 100 was stretched in all the directions in a plane parallel to the surface of the current collector 100. In this manner, the electrode 2 was obtained.

Next, the electrode 2 was observed using a scanning electron microscope in the normal direction to the current collector. As a result, it was confirmed that in the electrode 2, the current collector was elongated in the X direction in addition to the Y direction. The planar void ratio of the active material layers of the electrode 2 was 28%. In this example also, like in Example 1, it was found that the width of the active material bodies was not changed almost at all but the interval between adjacent active material bodies was mainly elongated.

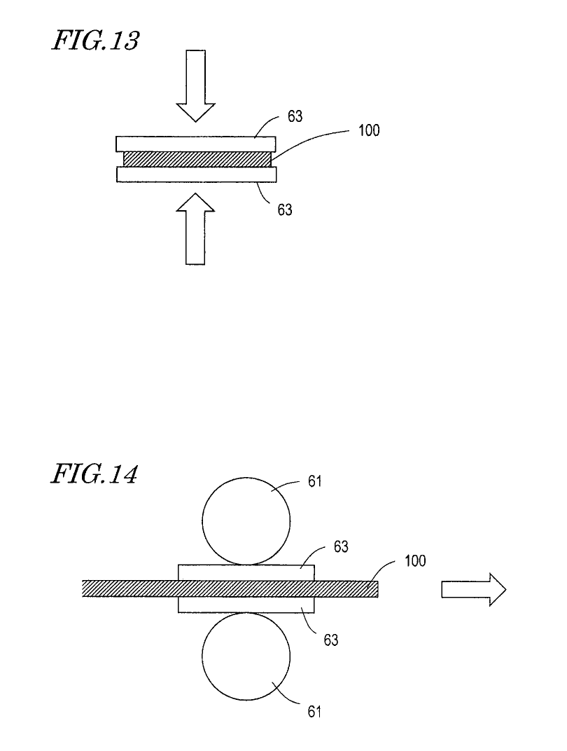

In Example 2, the current collector 100 was fixed when being rolled. In the case where, for example, a sheet-like current collector is used, the rolling may be performed using a device as shown in FIG. 14. Specifically, the current collector 100 is held between two rubber plates 63. Next, the current collector 100 is pulled in a direction of the arrow while being compressed using a roller 61 provided on a surface of each plate 63 opposite to the surface in contact with the current collector 100. Thus, the sheet-like current collector 100 can be rolled continuously and efficiently.

For rolling performed as shown in FIGS. 12 and 13, there is no specific limitation on the rubber as long as the rubber is stretchable. In the case where the rubber has anisotropy in the stretchable direction, the current collector 100 can be elongated in one axial direction. In the case where the rubber has isotropy in the stretchable direction, the current collector 100 can be elongated in two axial directions.

### INDUSTRIAL APPLICABILITY

A negative electrode for a lithium secondary battery according to the present invention is applicable to various lithium secondary batteries including, for example, coin-shaped, cylindrical, flat, and polygonal lithium secondary batteries. These lithium secondary batteries have a superior charge/discharge cycle characteristic than the conventional lithium secondary batteries while having a large charge/discharge capacity. Therefore, these lithium secondary batteries are widely usable for mobile information terminals such as personal computers, mobile phones, PDAs and the like; audio visual devices including video recorders, memory audio players and the like, etc.

### REFERENCE SIGNS LIST

200 Electrode
11, 91 Current collector
12, 92 Bump
14 Active material body
15a, 15b Active material layer
16a, 16b Space
D Normal direction with respect to the surface of the current collector

S Growth direction of the active material body
41 Vacuum chamber
42 Gas introduction pipe
43 Fixing table
46 Crucible
45 Oxygen nozzle
49 Silicon atom
50 Horizontal face

1. A method for producing an electrode for a lithium secondary battery, comprising:
(A) a step of causing a vaporized vapor deposition material to be incident on a surface of a current collector, having a plurality of bumps at the surface thereof, in a direction inclined with respect to the normal direction to the surface of the current collector, thus to form an active material body on each of the plurality of bumps of the current collector; and
(B) a step of stretching the current collector having the active material bodies formed thereon in at least one axial direction parallel to the surface of the current collector.

2. The method for producing an electrode for a lithium secondary battery of claim 1, wherein:
in the step (A), each of the active material bodies is formed while having a space with an adjacent active material body thereto; and
the step (B) is the step of stretching the current collector so as to enlarge a width of the space.

3. The method for producing an electrode for a lithium secondary battery of claim 1, wherein the step (B) is the step of stretching the current collector such that the current collector having the active material bodies formed thereon obtains a length equal to, or greater than, 100.5% of the pre-stretching length in the one axial direction by plastic deformation.

4. The method for producing an electrode for a lithium secondary battery of claim 1, wherein the pre-stretching current collector has a rupture elongation ratio of 1.0% or greater.

5. The method for producing an electrode for a lithium secondary battery of claim 1, wherein the step (B) stretches the current collector having the active material bodies formed thereon by a ratio which is 95% or less of the rupture elongation ratio of the pre-stretching current collector.

6. The method for producing an electrode for a lithium secondary battery of claim 1, wherein the step (B) includes the step of stretching the current collector in a direction perpendicular to the incidence direction of the vaporized vapor deposition material on a plane parallel to the surface of the current collector.

7. The method for producing an electrode for a lithium secondary battery of claim 1, wherein the step (B) includes the step of stretching the current collector in two axial directions on a plane parallel to the surface of the current collector.

8. The method for producing an electrode for a lithium secondary battery of claim 1, wherein the active material bodies contain silicon or tin.

9. The method for producing an electrode for a lithium secondary battery of claim 1, wherein the active material bodies contain a silicon oxide, and an amount of oxygen has a molar ratio x of greater than 0 and less than 1.5 with respect to an amount of silicon in the active material bodies.

10. An electrode for a lithium secondary battery produced using the method of claim 1.
